(19) United States
(12) Patent Application Publication
(10) Pub. No.: US 2015/0300556 A1
(43) Pub. Date: Oct. 22, 2015

(54) PENNY BANK AVAILABLE FOR PLACING ELECTRONIC DEVICE

(71) Applicant: Eagle FAN, Chu-Pei City (TW)

(72) Inventor: Eagle FAN, Chu-Pei City (TW)

(21) Appl. No.: 14/255,356

(22) Filed: Apr. 17, 2014

(51) Int. Cl. F16M 13/02; A45C 1/12

(52) U.S. Cl. CPC F16M 13/02; A45C 1/12

(57) ABSTRACT

The present invention provides a penny bank available for placing electronic device, including a hollow container with a coin slot. The penny bank further includes a stop part and a support part. The support part is located higher than the stop part. When an electronic device is placed on the penny bank, the stop part contacts a bottom edge of the electronic device to stop the electronic device from sliding. The support part contacts a back of the electronic device so that the electronic device can stand in a tilt position on top of the penny bank. As such, the penny bank is placed on the desk for storing coin and provides a place for placing electronic device, such as, smart phone or tablet.

### TECHNICAL FIELD

The technical field generally relates to a penny bank, and more particularly to a penny bank available for placing electronic device.

### BACKGROUND

A penny bank, often called piggy bank, is a container for coins. With small size and various designs, the penny bank is often placed on desk for decoration as well as storing coins. On the other hand, as the electronic devices, such as, smart phones or 5-7 in tablet, becomes popular, many users place these devices on desk for easy access or to view videos. As a result, various products are designed for placing the electronic device on the desk so that the electronic device can easily stand on the desk for convenient viewing.

However, as the desk space is a rare commodity in most working spaces, it is desirable to design an item that is able to serve multiple functions.

### SUMMARY

A primary object of the present invention is to provide a penny bank with additional function. In addition for containing coins, the penny bank is designed for providing a place for an electronic device to sit on. Therefore, in addition to containing coins and decorating the desk, the penny bank of the present invention can also be used as a base for placing an electronic device.

To achieve the above object, the penny bank of the present invention a hollow container with a coin slot. The penny bank further includes a stop part and a support part. The support part is located higher than the stop part. When an electronic device is placed on the penny bank, the stop part contacts a bottom edge of the electronic device to stop the electronic device from sliding. The support part contacts a back of the electronic device so that the electronic device can stand in a tilt position on top of the penny bank.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a first embodiment of the present invention;

FIG. 2 shows a schematic view of the first embodiment of the present invention in actual application;

FIG. 3 shows a dissected view of a first embodiment of the present invention;

FIG. 4 shows a schematic view of a second embodiment of the present invention;

FIG. 5 shows a schematic view of the second embodiment of the present invention in actual application;

FIG. 6 shows a schematic view of a third embodiment of the present invention;

FIG. 7 shows a schematic view of the third embodiment of the present invention in actual application; and

FIG. 8 shows a schematic view of the support part of the third embodiment in a folded state.

### DETAILED DESCRIPTION OF THE DISCLOSED EMBODIMENTS

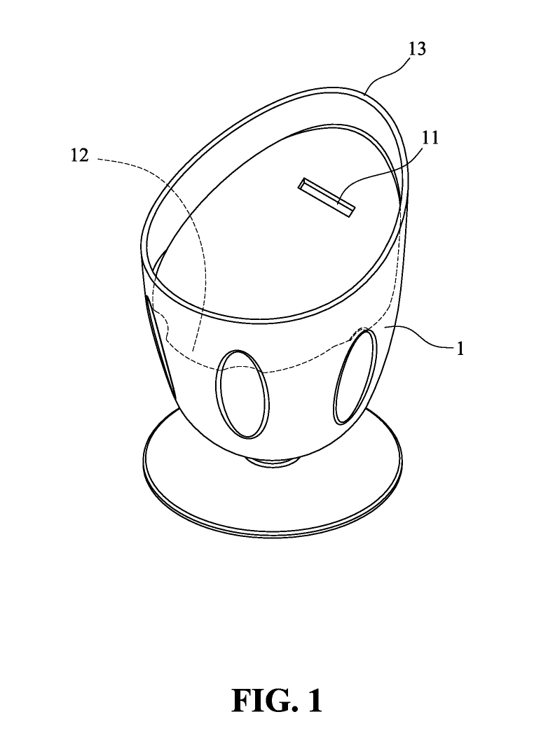

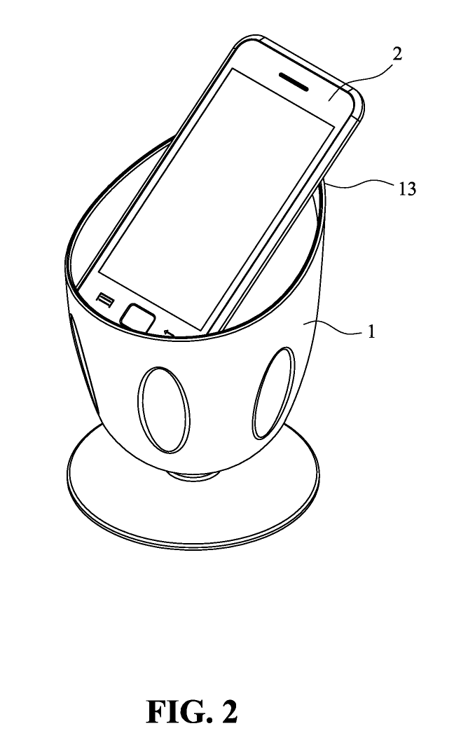

FIG. 1 shows a schematic view of a first embodiment of the present invention; and FIG. 2 shows a schematic view of the first embodiment of the present invention in actual application. A penny bank 1 of the present invention is a hollow container with a coin slot 11. A stop part 12 and a support part 13 are formed on the penny bank 1. The support part 13 is located higher than the stop part 12. When an electronic device 2 is placed on top of the penny bank 1, the stop part 12 contacts the bottom edge of the electronic device 2 to stop the electronic device 2 from sliding downward. The support part 13 contacts the back of the electronic device 2 so that the electronic device 2 can stand in a tilt position on top of the penny bank 1.

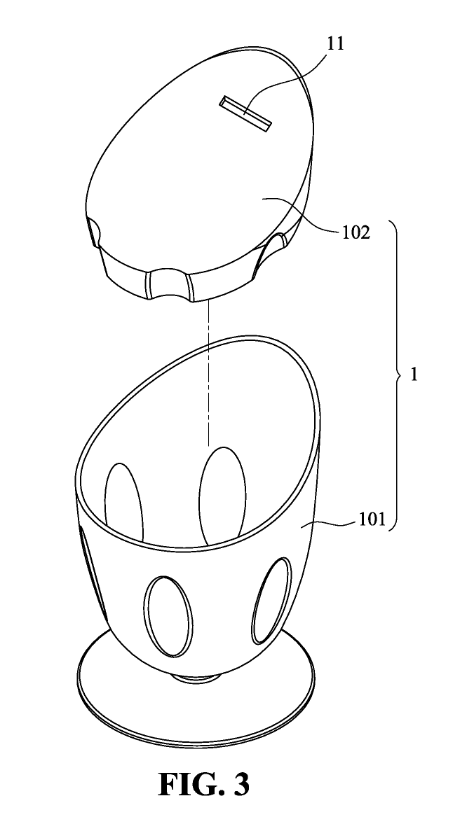

The shape of the penny bank 1 is not restricted to any specific form, as shown in FIG. 1 and FIG. 3. In the present embodiment, the penny bank 1 is formed by a cup-shaped body 101 and a decorative plate 102 forming a surface inside the cup-shaped body 101. As such, the penny bank has an appearance of a goblet filled with liquid to a certain level. The decorative plate 102 is disposed inside the cup-shaped body 101, and forms a housing space with the cup-shaped body 101 to contain coins. The coin slot 11 is disposed at the decorative plate 102 for inserting coins. The support part 13 is located at the edge of the cup-shaped body 101. the stop part 12 is formed by the upper surface of the decorative plate 102 and the neighboring inner wall of the cup-shaped body 101. To prevent from sliding, the upper surface of the decorative plate 102 may be made of material with higher friction coefficient, such as, sponge or soft pad. In this embodiment, the penny bank 1 is for placing a narrower electronic device 2, such as, a smart phone (as shown in FIG. 2). If the smart phone is wider than the mouth of the cup-shaped body 101, a different design may be adopted.

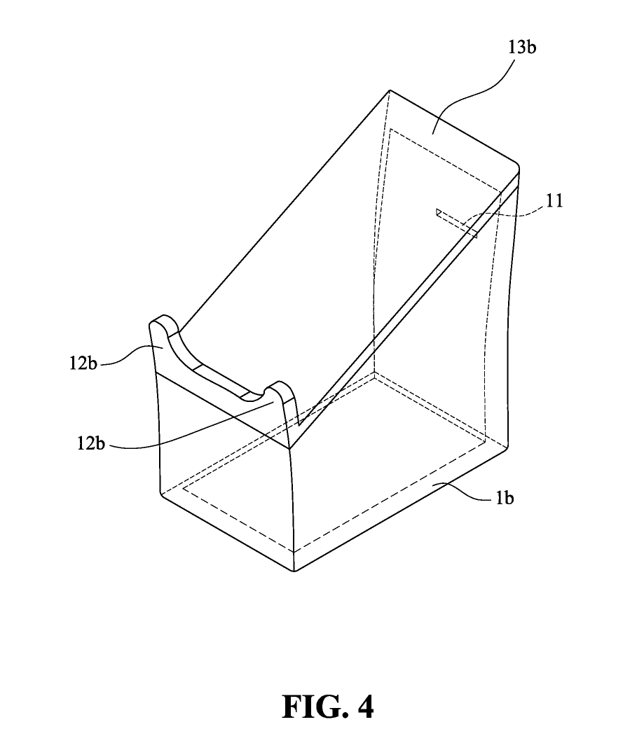

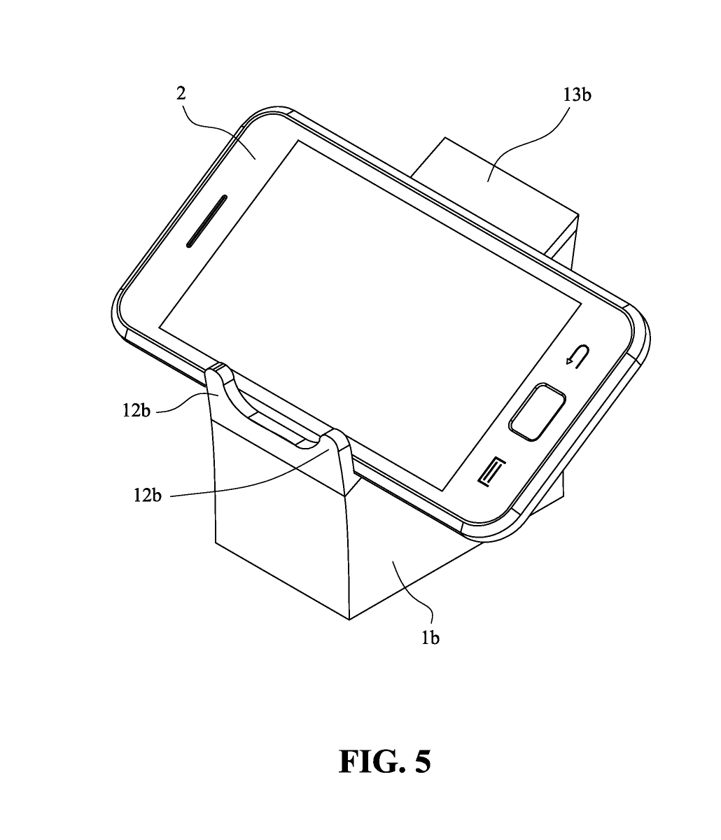

FIG. 4 shows a schematic view of a second embodiment of the present invention; and FIG. 5 shows a schematic view of the second embodiment of the present invention in actual application. In the present embodiment, the penny bank 1b has a shape of a podium and is also a hollow container. The coin slot 11 is disposed at the vertical side wall. The stop part 12b and the support part 13b are disposed at the top of the penny bank 1b. The stop part 12b is located lower than the support part 13b. In the present embodiment, the support part 13b is a slant surface and the stop part 12b is a stop block protruding from the upper surface of the penny bank 1b. When the electronic device is placed on the penny bank 1b, the support part contacts to support the back of the electronic device 2, and the stop part 12 stops the bottom edge of the electronic device 2 from sliding. The advantage of the present embodiment is that the electronic device 2 can be placed on the penny bank 1b in a horizontal or vertical position, and is therefore applicable to electronic devices of various width and types.

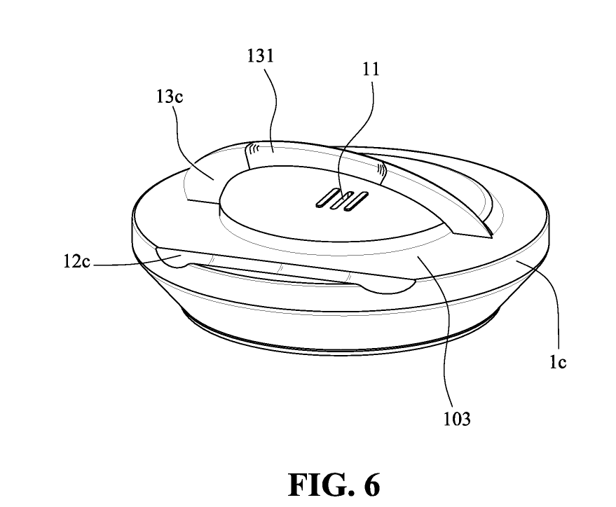

FIG. 6 shows a schematic view of a third embodiment of the present invention. In the present embodiment, the penny bank 1c is a flat large hollow container, disposed with a coin slot 11, a support part 13c and a stop part 12c, and the support part 13c is located higher than the stop part 12c. In the present embodiment, the support part 13c is coupled to the penny bank 1c and is located at upper surface 103. The coupling structure provides certain tightness, and when the support part 13c is flipped upwards by an external force and the external force vanishes afterwards, the support part 13c will still maintain an angle with the upper surface 103. The middle segment of the support part 13c is disposed further with a slipping-proof element 131. The slipping-proof element 131 is made of material with high friction coefficient. When in use, the slipping-proof element 131 contacts the back of the electronic device 2 to prevent the electronic device 2 from tipping over. The stop part 12c is trench formed at the upper surface 103.

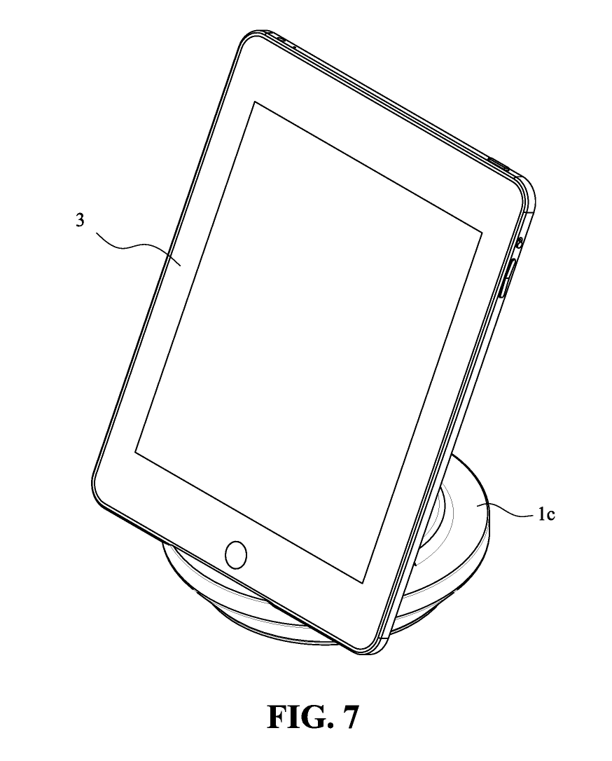

FIG. 7 shows a schematic view of the third embodiment of the present invention in actual application. As shown in FIG. 3, because the penny bank 1c is of a flat large shape, and therefore a wider tablet 3 can be placed on. Because the trench (i.e., the stop part 12c) engages the bottom edge of the tablet 3, the support part 13c is able to support and fix the tablet 3 when contacting the back of the tablet 3.

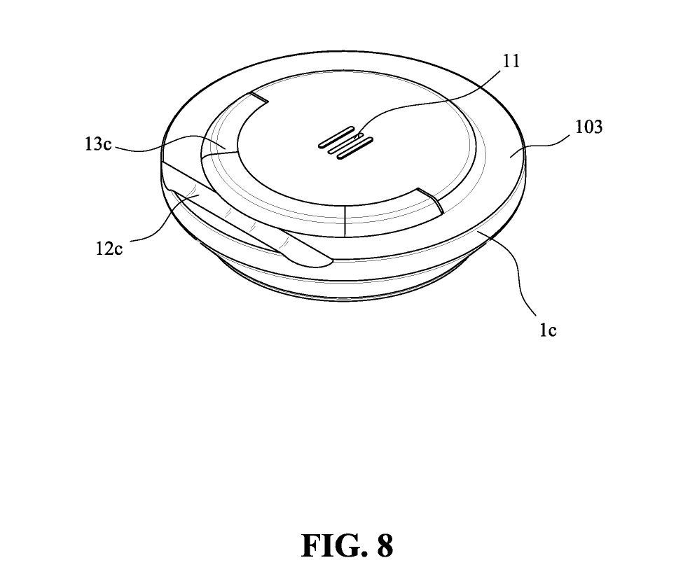

FIG. 8 shows a schematic view of the support part of the third embodiment in a folded state. As shown in FIG. 8, the support 13c is coupled to the penny bank 1c. When not in use for supporting, the support part 13c can be flipped downward to contact the upper surface 103 for simplicity in appearance.

It will be apparent to those skilled in the art that various modifications and variations can be made to the disclosed embodiments. It is intended that the specification and examples be considered as exemplary only, with a true scope of the disclosure being indicated by the following claims and their equivalents.

1. A penny back available for placing electronic device, comprising: a hollow container with a coin slot, a stop part and a support part; wherein the support part being located higher than the stop part; when an electronic device being placed on the penny bank, the stop part contacting a bottom edge of the electronic device to stop the electronic device from sliding; the support part contacting a back of the electronic device so that the electronic device able to stand in a tilt position on top of the penny bank.

2. The penny bank as claimed in claim 1, wherein the hollow container of the penny bank is formed by a cup-shaped body and a decorative plate which forming a surface inside the cup-shaped body; the penny bank has an appearance of a goblet filled with liquid to a certain level; the support part is located at the edge of the cup-shaped body; and the stop part is formed by an upper surface of the decorative plate and a neighboring inner wall of the cup-shaped body.

3. The penny bank as claimed in claim 1, wherein the stop part and the support part are disposed at an upper surface of the penny bank, the stop part is located lower than the support part, the support part is a slant surface and the stop part is a stop block protruding above the upper surface.

4. The penny bank as claimed in claim 1, wherein the support part is coupled to the penny bank and is located at an upper surface of the penny bank; the coupling structure provides a certain amount of tightness so that when an external force flipping the support part upwards vanishes afterwards, the support part will still maintain an angle with the upper surface.

5. The penny bank as claimed in claim 4, wherein the support part has a middle segment disposed further with a slipping-proof element; and when in use, the slipping-proof element contacts the back of the electronic device.

6. The penny bank as claimed in claim 1, wherein the stop part is trench formed at an upper surface of the penny bank.
